(19) United States
(12) Patent Application Publication
(10) Pub. No.: US 2005/0123377 A1
(43) Pub. Date: Jun. 9, 2005

(54) Hook nut connector assembly

(76) Inventors: John Boyland, Christiansburg, VA (US); Wei Tong, Blacksburg, VA (US); Laszlo Bartha, Valla (SE); Oystein Krogen, Flen (SE)

Correspondence Address: MORGAN & FINNEGAN, L.L.P., 3 WORLD FINANCIAL CENTER, NEW YORK, NY, 10281-2101, US

(21) Appl. No.: 10/759,877

(22) Filed: Jan. 16, 2004

Related U.S. Application Data
(60) Provisional application No. 60/520,107, filed on Nov. 13, 2003.

(51) Int. Cl. F16B 33/00

(52) U.S. Cl. 411/367

(57) ABSTRACT

The present invention provides an apparatus that fastens elements of a frame assembly. The frame assembly implements fasteners as independent elements from both a housing and a corresponding housing cover. Exemplary embodiments of such fasteners may include the hook nut fasteners disclosed herein. Generally, such fasteners include a central portion providing a contact area disposed in the plane of a housing fastening aperture, an extension tab providing a contact area on a housing interior wall, and an extension block providing a contact area on a housing exterior wall. The extension block may include a hollow portion configured to receive a securing bolt. One advantageous application of the invention relates to automobile motor assembly housings. Specifically, in that embodiment the hook nut fastening assembly reinforces the motor housing and provides additional support to the assembly by reinforcing the joints between an end-cover and a motor assembly main body.

### RELATED APPLICATION

The instant application hereby claims priority to the U.S. provisional patent application Ser. No. 60/520,107 for a “Hook Nut Connector Apparatus” filed on Nov. 13, 2003, which is also incorporated by reference herein.

### FIELD OF THE INVENTION

This invention relates generally to a type of fastener, more particularly, to an apparatus that may be used to assist in assembling a motor frame.

### BACKGROUND OF THE INVENTION

An exemplary application of the present invention relates generally to facilitating assembly of an electric motor that typically has an external motor housing and two end shields or housing covers mounted on opposing lateral ends of the housing for holding the motor components therein.

Electric motors are manufactured in a variety of types and configurations. Typically an electric motor assembly is formed from a collection of parts, including elements such as a stator, a rotor, a shaft, a pair of end shields (or end bells), bearings, and a motor housing supporting and enclosing the various components. In addition to these primary motor components, some motors may include electronic components that are used to modify operating characteristics for particular applications. A hollow substantially cylindrical shaped housing includes axial opposite end surfaces, and a rotor and shaft rotatably disposed within the hollow interior bore of the housing. The stator has windings wound axially through the stator, and end-turns from the stator windings are positioned adjacent to the stator end surfaces. The end shields protect the stator windings and end turns from inadvertent contact and grounding while providing a mounting surface for rotor bearings and shaft bushings. The end shields also prevent debris from entering the hollow interior of the stator and interfering with operation of the motor.

Conventionally, there are a number of ways to assemble motor frames. One such method is to use nuts, in coordination with long bolts (or in the alternative key bars), which extend through a distal side of one end shield, through the housing and through the opposite end shield, to secure the assembly together, as shown in U.S. Pat. No. 5,412,270. The high compressive forces produced by bolts act to maintain the end shields in a static position with respect to the housing. This assembly method is especially suitable for a motor with a lower length-to-diameter ratio. For motors with larger length-to-diameter ratios, however, this assembly method is prohibitive due to the structural instability inherent as the length of the bolts increases to match the greater length of the motor.

Another frame assembly method incorporates tapping directly at the housing end surfaces, creating attachment sites (i.e., threaded spaces) integrally as part of the housing itself. Specifically, short bolts are threaded into the housing through the end shield. However, this necessitates either a significant increase in the housing wall thickness, or a housing design with complex structures formed with additional material that integrally provide a portion of the housing configured to receive a bolt or a screw.

Electric motors to which the present invention pertains are common in the art. These motors, for example, might be used in electric vehicles. However, there is in a need for viable frame assembly methods that are formed so as to reduce both manufacturing costs and assembly cycle time. Moreover, it would be especially advantageous if the assembly elements did not need to be accounted for at the initial stage of forming the housing or housing cover. Such assembly methods should provide reliable and cost effective ways for facilitating normal motor operation.

### SUMMARY OF THE INVENTION

The present invention provides frame assemblies with fasteners implementing hook nut reinforcement, which addresses the concerns discussed above. Specifically, in an advantageous embodiment, a hook nut fastener reinforces the motor housing so as to provide additional support to the assembly by reinforcing the joints between an end-cover and a motor assembly main body.

Typically, a motor housing is formed into a cylindrically shaped tube and end covers are attached to the tube after the motor is inserted. According to an advantageous embodiment, a fastener is configured to engage the motor housing, a securing bolt, as well as a housing cover. Fastening apertures are formed in the lateral ends of the housing. The fastener includes elements that engage the housing through a plurality of contact areas. Specifically, the fastener includes a central portion that establishes a contact area in the plane of the aperture, as well as a base extension tab that establishes at least one contact area with the interior wall of the housing. The fastener also includes an extension block that establishes a contact area with the exterior of the housing and engages a securing bolt. The securing bolt threads through an aperture in the housing cover and engages the fastener, thereby securing the housing cover to the housing, situated between the securing bolt head and the fastener's extension block.

Advantageously, this type of fastener, a hook nut fastener, reinforces the motor housing so as to provide additional support to the assembly by reinforcing the joints between an end-cover and a motor assembly main body. Furthermore, the invention secures the housing cover to the housing by simply engaging the housing and the securing bolt. Accordingly, the fastener acts to simplify housing/housing cover manufacturing and the assembly process.

### BRIEF DESCRIPTION OF DRAWINGS

FIG. 1 is a perspective view of an exemplary motor housing with fastening apertures formed at the axial ends of the housing.

FIGS. 2A-2B is a perspective view of an exemplary embodiment of the present invention illustrating a triangle-base hook nut.

FIGS. 3A-3D illustrate a method of assembly for a motor housing assembly utilizing the exemplary embodiment shown in FIGS. 2A-2B.

FIGS. 3E and 3F illustrate top views of a central portion and a base extension tab before and after a fastener is rotated, as shown in FIGS. 3A-3D.

FIG. 4A is a perspective view of an exemplary square-base hook nut embodiment of the invention.

FIG. 4B is a cross-sectional view of a central portion and a base extension tab for the square-base hook nut embodiment of FIG. 4A.

FIG. 4C illustrates the insertion and rotation of a fastener according to the embodiment illustrated in FIGS. 4A and 4B.

FIG. 5A is a perspective view of an exemplary Z-type hook nut.

FIG. 5B is an illustration showing of a Z-type hook nut engaged with a housing and an end shield.

FIG. 6A-6B illustrate a fastener according to an alternate exemplary embodiment of the invention, wherein the fastener is engaged with the housing from the interior.

FIG. 7 illustrates a fastener according to a further exemplary embodiment of the invention, wherein a central portion and a base extension tab are cylindrical.

FIG. 8 illustrates the invention according to an additional exemplary embodiment implementing a detachable base extension tab.

### DETAILED DESCRIPTION

In the following description of the various embodiments, reference is made to the accompanying drawings which form a part hereof, and in which is shown by way of illustration various embodiments in which the invention may be practiced. It is to be understood that other embodiments may be utilized and structural and functional modifications may be made without departing from the scope of the present invention.

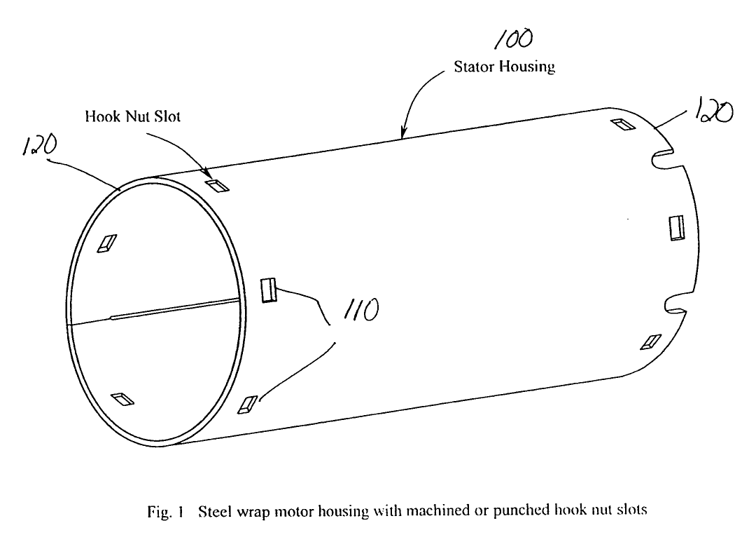

FIG. 1 illustrates an exemplary housing prior to inserting a motor and securing housing covers to the housing. Generally, a motor is inserted into a protective casing to protect the various motor components. As shown in FIG. 1, a motor housing 100 may be formed as a hollow cylindrical tube. The tube is manufactured with axial ends 120 remaining open to facilitate motor insertion. Once the stator core and the rotor are inserted, the axial ends are covered with end shields (not illustrated) which correspond to the circumference of the cylindrical tube and block off the axial ends 120. In the embodiment illustrated in FIG. 1, the cylindrical tube is formed from a single piece of sheet metal that includes rectangular fastener apertures 110 formed adjacent to the lateral ends 120. A motor housing may be formed in steel, aluminum, or another type of suitable metal.

The fastening apertures 110 may be formed in the sheet metal, by any known method of metal working, such as machining, punching or stamping. Moreover, it is to be understood that the fastener apertures 110 are not limited to rectangular shapes. Depending on the specific application and the manufacturing process, the fastening apertures 110 may be circular, elliptical, pear-shaped, triangular, irregular, or any other shape tailored for a matching fastener. To ease the installation process, the dimension of the fastening aperture 110 on the housing is slightly larger than that of a fastener's base extension tab (discussed below).

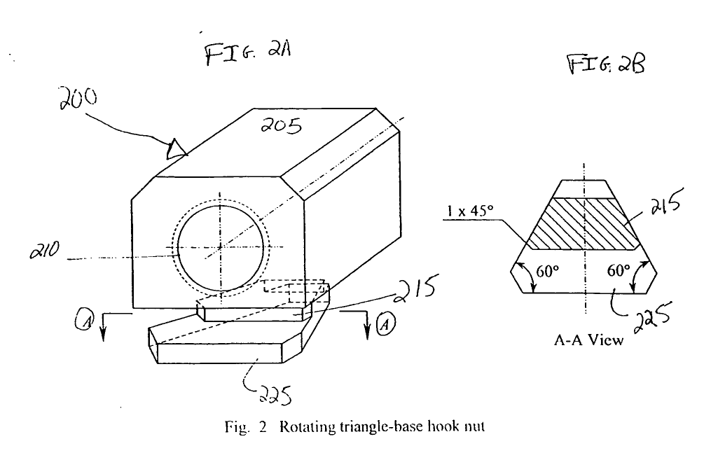

FIGS. 2A and 2B illustrate a perspective view of an exemplary embodiment of the present invention. Specifically, FIG. 2A illustrates a triangle-base hook-nut fastener 200 with a triangular-shaped base extension tab 225. The triangle-base hook nut fastener 200 includes a substantially rectangular box, which when engaged with the housing 100, forms an extension block or extension body 205 of the fastener 200. Extension block 205 includes a hollow portion 210 extending the length of external block 205.

Based on the specific application of the fastener, the interior of the hollow portion 210 may be formed with threads to complement corresponding threads on a securing bolt, such as a screw. As another example, the hollow portion 210 may be smooth, and configured to accept a pin with a spring-loaded locking mechanism at the distal end. It is to be understood that numerous other securing mechanisms would be apparent to one of skill in the art.

In the various embodiments of the invention, the fastener utilizes both horizontal and vertical forces in relation to the housing when the fastener engages the housing's fastening aperture. The extension block and base extension tab may impart forces on the exterior and interior housing walls in a vertical direction. These vertical forces work in coordination with horizontal forces imparted by the central portion of the fastener and the force created by engaging a securing bolt with the extension block.

With regard to engaging the securing bolt with the extension block, the securing bolt used during the fastening process applies a load to the fastener. The load works, in coordination with the fastener contact areas, to maintain the vertical and horizontal fastener position with respect to the housing, the housing cover, and the securing bolt. The contact areas apply a retaining force or pressure to the interior and exterior walls of the housing, as well as apply a force in the plane of a fastening aperture portion of the housing. Moreover, it is to be understood that hollow portion 210 does not necessarily have to extend the entire length of extension block 205. If the securing bolt is a screw, the hollow portion 210 may extend only a certain length of the extension block 205. Also, hollow portion 210 may decrease in circumferential diameter as the hollow portion 210 extends into the extension block 205. Such an embodiment advantageously provides additional anchoring material for engaging a screw.

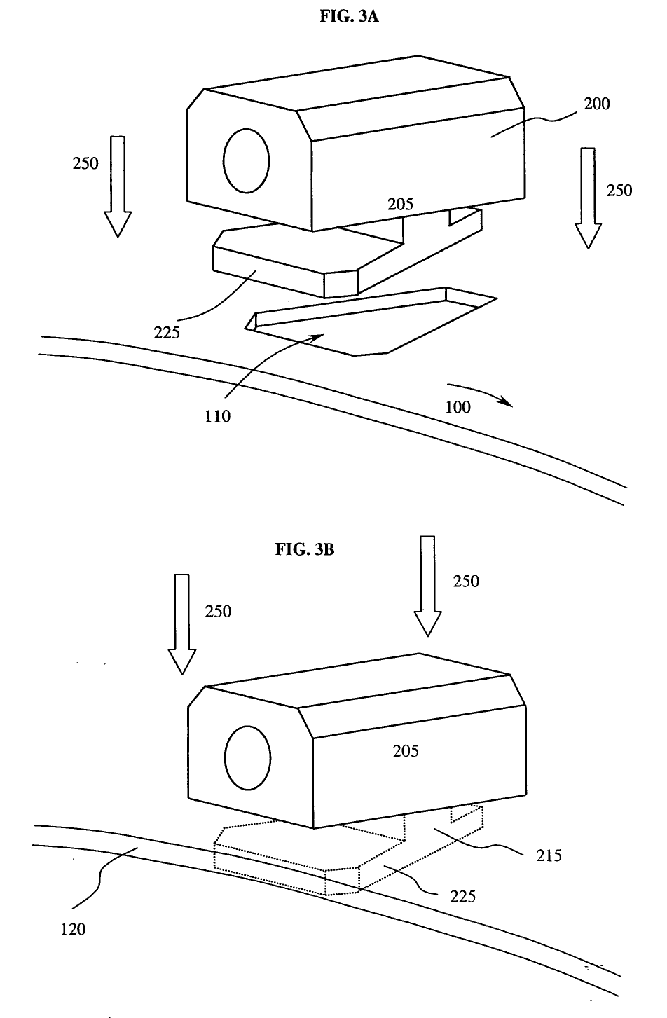

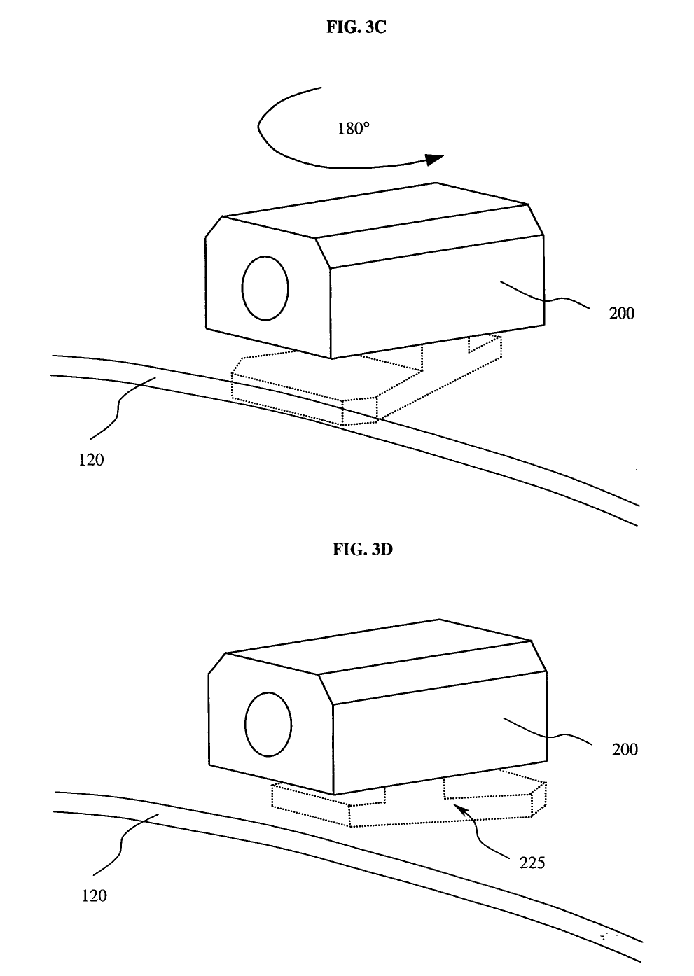

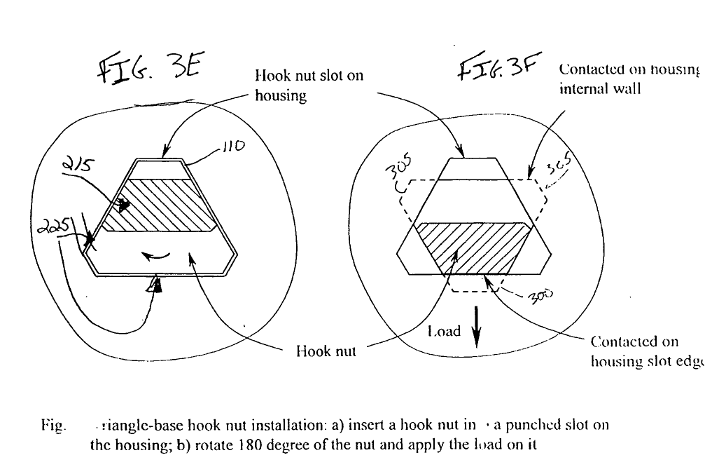

The underside of extension block 205 joins central portion 215 to create a second section of fastener 200. The central portion 215 lies in the plane of the fastening aperture 110, when the fastener 200 engages the housing 100. Central portion 215 also separates the base extension tab 225 and extension block 205 in fastener 200. The central portion 215 is formed so that after the fastener 200 is rotated (to be described with regard to FIGS. 3A-3D in greater detail below) the central portion 215 provides additional structural support, as well as an additional contact area between the fastener 200 and housing 100. Generally, both the extension block 205 and the base extension tab 225 extend beyond the central portion 215 to engage the surface of the housing. This advantageously allows for the fastener to firmly engage both the interior and exterior sides of the housing wall, as well as a securing bolt.

FIG. 2B illustrates a cross-sectional view of triangular base extension tab taken along lines A-A in FIG. 2A. It is to be understood for a given embodiment both fastening aperture 110 and the base extension tab 225 are designed to match and work together. Generally, the base extension tab 225 is formed with a similar contour as the fastening aperture 110, but it is to be understood that in some embodiments the contours may be shaped differently. The shape of the fastening aperture 110 on housing 100 also contributes to determining the shape of central portion 215 (shown shaded). The wedge shape of central portion 215 allows it to engage the triangular fastening aperture 110. As shown in FIG. 2B, the geometry of forming the fastening aperture 110 substantially in the shape of a triangle leads to a complementary contoured triangular base extension tab 225. Varying the shape of the fastening aperture 110 leads to subtle implementation variances in the placement of the retention forces securing the elements and will be illustrated in alternate embodiments detailed below.

FIGS. 3A-3D illustrate the steps of engaging the fastener with the housing 100 for an exemplary hook nut fastener with a triangular base extension tab. Initially, as shown in FIG. 3A, the fastener 200 is positioned above a fastening aperture 110, thereby aligning the complementary contours of the triangular base extension tab 225 and the fastening aperture 110. After the elements are aligned, the fastener 200 is inserted into the fastening aperture 110 in the direction of arrows 250. In FIGS. 3B-3D, the central portion 215 and the triangular base extension tab 225 are represented by dashed lines because they are in the plane of or beneath the fastening aperture 110 and on the interior side of the housing 100. In an embodiment of the invention to ensure a secure connection between the fastener 200 and the housing 100, the thickness of the central portion 215 is equal to the housing thickness. FIG. 3B shows the triangular hook nut fastener 200 with central portion 215 and base extension tab 225 inserted into fastening aperture 110. The extension block 205 prevents the fastener 200 from fully passing through fastening aperture 110 and advantageously provides another area of contact between the fastener 200 and the housing 100. As shown in FIG. 3C, once the fastener 200 has been inserted, the fastener 200 is rotated by 180° with respect to the axial edge 120 of the housing 100. FIG. 3D illustrates fastener 200 in the final rotated position with the base extension tab 225 extending away from an axial edge 120. The degree of rotation is one of the subtle implementation-specific aspects of the fastening processes referenced above.

In the embodiment illustrated in FIG. 3C, the geometry associated with a triangular base extension necessitates a 180° rotation for the fastener 200. The 180° rotation illustrated in FIG. 3E from a top perspective creates staggered contact areas for the apex 300 and the base corners 305 of the base extension tab 225 and the triangular aperture 110. In FIG. 3E, the base extension tab 225, and the complementary aperture 110 are aligned to facilitate insertion of fastener 200 into the aperture 110. As shown, central portion 215 is set back from the leading edge of the base extension tab 225.

FIGS. 3E and 3F illustrate the fastener from a top view before and after the rotation of fastener 200, respectively. The apex 300 of the base extension tab 225, and the base corners 305 of the base extension tab 225 are rotated into the position illustrated in FIG. 3F. Rotating the fastener provides for three contact areas on the interior surface of the assembly housing, which in turn, provides additional structural support for the fastening assembly. Specifically, as the hook nut is inserted into the slot and turned around 180 degrees, the three corners of the base extension tab 225 engage the housing's internal wall, thereby providing radial support for balancing the bending moment acting on the fastener as the securing bolt is engaged.

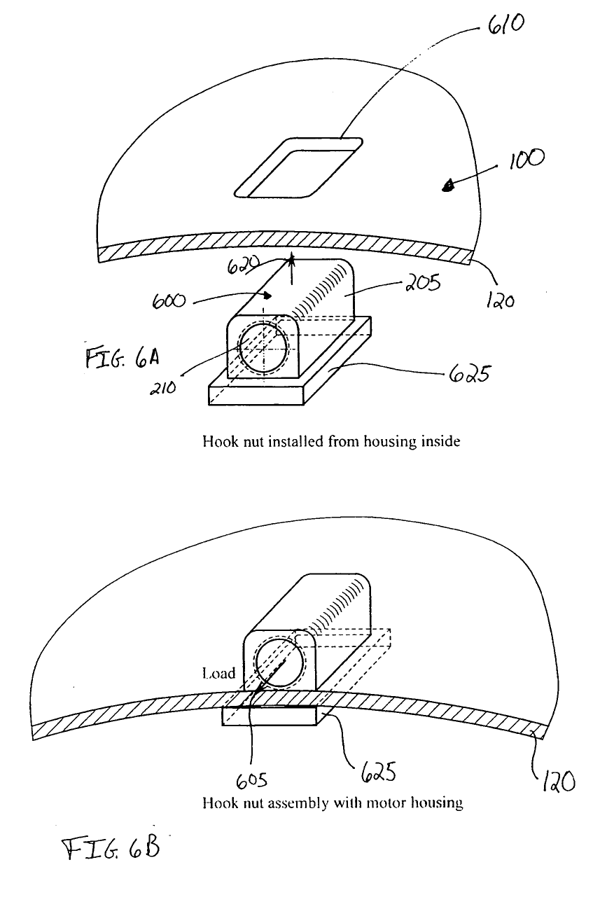

Once the fastener is engaged with the housing, the other elements of the assembly may be secured to the housing. The fastener 200 also includes an extension block 205 that establishes a contact area with the exterior of the housing and engages a securing bolt (not illustrated). The securing bolt threads through an aperture in the housing cover and engages the hollow portion of the extension block. The engaged securing bolt and fastener rigidly secure the housing cover between the securing bolt head and the fastener's extension block. This securing process is illustrated in greater detail in FIG. 5B for a Z-type hook nut fastener. It is to be understood that the fastener may work alone or in coordination within other fasteners situated at areas along the circumference of the axial end 120 to secure the housing cover 315 to the housing 100.

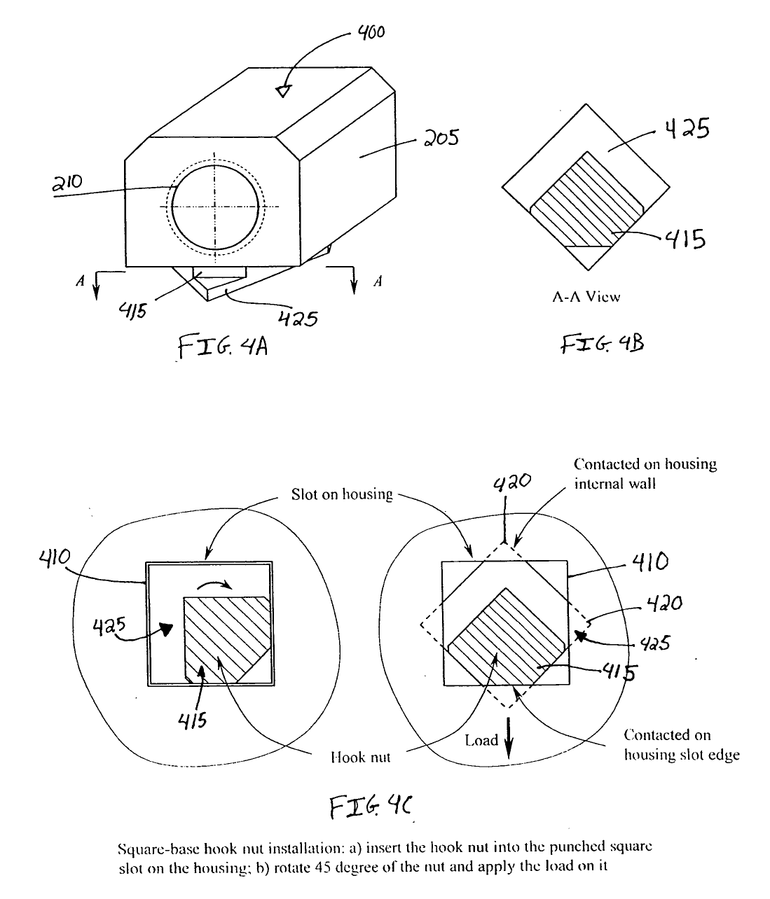

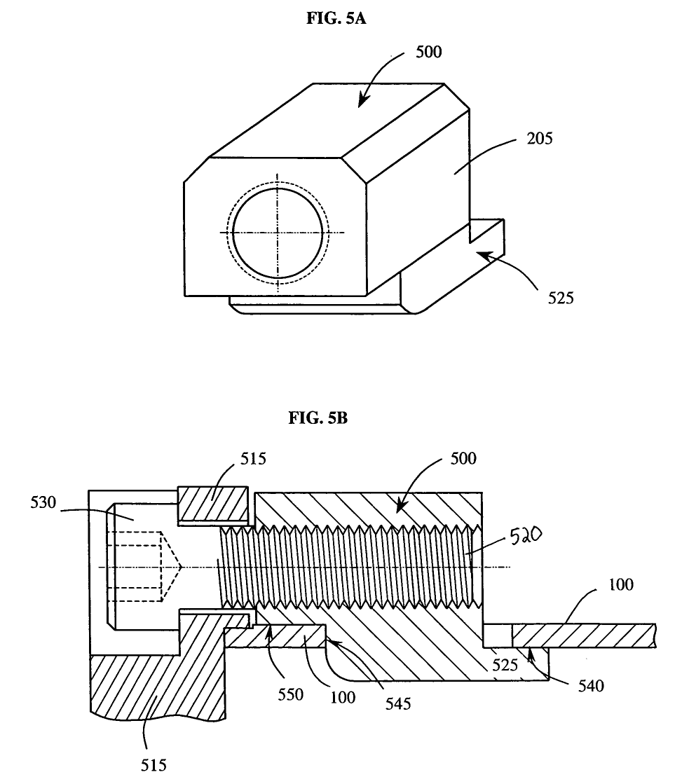

FIG. 4A illustrates a perspective view of an alternate exemplary embodiment of the invention, specifically a square hook nut fastener. As shown in FIG. 4A, the embodiment is similar to the embodiment shown in FIGS. 3A-3G, except that the central portion 415 and the base extension tab 425 of the square hook nut fastener 400 are substantially square shaped. This aspect of the embodiment can be seen in greater detail in FIG. 4B. In FIG. 4B, the central portion 415 of the square hook nut fastener 400 is set back from the edge of the base extension tab 425. As discussed above, this allows for an additional contact area when the fastener 400 engages the housing 100.

FIG. 4C illustrates the process of inserting the fastener 400 with a square shaped base extension tab 425 into the fastening aperture 410. As discussed above, varying the geometry of the fastening aperture 410, the base extension tab 425, and central portion 415 leads to subtle differences in the placement of the retention forces. Specifically, as the fastener 400 engages the securing bolt 320 and the housing 100, there are different retaining forces exerted on the interior wall of housing 100 by the square base extension tab 425. As shown in FIG. 4C, the square-shaped base extension tab 425 has four independent areas of contact 420 with the interior wall of the housing 100. Further, due to the geometry associated with this embodiment, the fastener 400 is rotated 45° to engage the fastener 400 with the housing 100. The other aspects of engaging the fastener 400, the housing 100, the housing-cover, and the securing bolt 320 are similar to those discussed above with regard to triangle-base fastener discussed above.

FIG. 5A illustrates a fastener according to an alternate exemplary embodiment of the invention. The fastener 500 in FIG. 5A has a Z-shaped side profile. Unlike the embodiments discussed above, the Z-type hook nut fastener 500 includes a base extension tab 525 that extends in a lateral direction opposite that of the extension block 205. Accordingly, the Z-type hook nut fastener 500 is tilted for inserting into a housing fastening aperture, but does not need to be rotated to engage the housing 100 and the securing bolt.

FIG. 5B illustrates in greater detail the Z-type hook nut fastener 500 engaged with the securing bolt 520, the housing 100, and a circumferential edge 515 of the housing-cover. As shown, the securing bolt 520 is a screw threaded into a Z-shaped fastener. Also, the securing bolt head 530, retains the outer circumferential edge of the housing cover 515, as the securing bolt 520 engages fastener 500. Moreover, FIG. 5B shows three areas of contact for fastener 500 with the housing 100—the base extension tab 525 is in contact with the interior wall of the housing 100 at contact area 540; the central portion of the fastener 515 in contact with the housing 100 in the plane of the fastening aperture 510 at contact area 545; and the extension block 205 in contact with the exterior of the housing 100 at contact area 550 for this embodiment of the invention. It is to be understood that the actual number of contact areas between the fastener 500 and the housing 100 may vary depending on application and the type of fastener utilized.

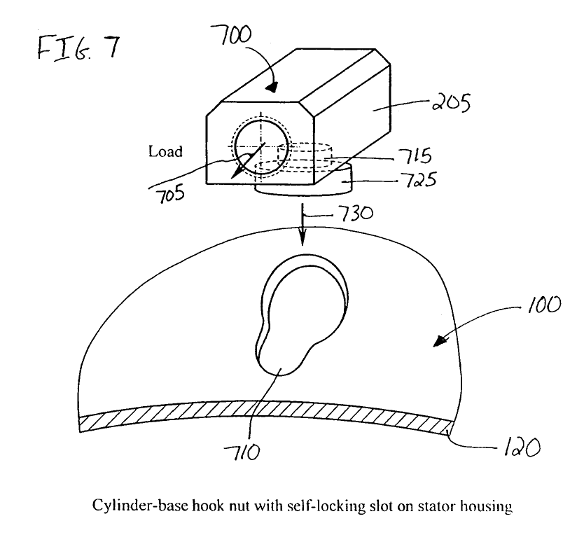

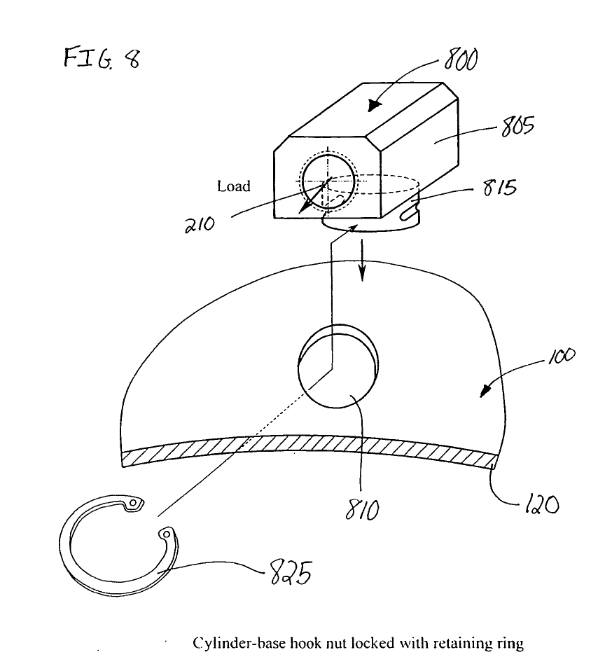

Furthermore, it is to be understood that depending on the geometry implemented for the hook nut fastener, the contact area of the base extension tab and the housing interior wall may vary. One exemplary contact area implementation may contact the housing's interior wall on the side of the fastening aperture closest to the axial end of the housing, as illustrated in FIG. 7 with the cylindrical hook nut. Specifically, the cylindrical base extension tab 725 contacts the interior wall of the housing on the side of fastening aperture 710 closest to the housing's axial end 120. Alternately, in the Z-type hook nut shown in FIG. 5B, the base extension tab 525 contacts the housing interior wall at contact area 540 on the side of the fastening aperture 510 opposite the housing's axial end 560. As shown in FIG. 6B, a circumferential base hook nut 600 contacts the housing's interior wall on both sides of the fastening aperture 610.

FIGS. 6A and 6B illustrate a circumferential base hook nut fastener according to an alternate exemplary embodiment of the invention, wherein the circumferential base hook nut fastener 600 is inserted into the fastening aperture 610 from the interior side of the housing 100. As shown, in FIG. 6A, the extension block 205 of fastener 600 is inserted along arrow 620 into the fastening aperture 610. This embodiment of the invention involves a fastener with a base extension tab 625 that extends around the entire circumference of the fastener. The continuous base hook nut 600 contacts the entire circumference of the interior wall of housing 100 along the fastening aperture 610. In FIG. 6B once the fastener 600 is inserted into the fastening aperture 610, a securing bolt (not illustrated) acts to apply a load along arrow 605. The securing bolt acts in coordination with the continuous base extension tab 625 to secure both the fastener 600 and the housing cover to the housing 100.

FIG. 7 illustrates a fastener according to an additional alternate exemplary embodiment of the invention for a cylindrical hook nut 700. The cylindrical hook nut 700, as the name implies, incorporates both a cylindrical central portion 715 and a cylindrical base extension tab 725. As shown, the base extension tab 725 and the central portion 715 are formed as cylindrical elements of fastener 700. In order to complement the cylindrical shape of these elements, fastening aperture 710, is generally pear-shaped with the smaller end of the aperture disposed toward the axial end 120 of the housing 100. This geometry facilitates the fastener's insertion along arrow 730 after which, the fastener 700 is moved along arrow 705 to engage both the housing 100 and a securing bolt (not illustrated), which acts to apply a load. With regard to FIG. 7 and FIG. 8, arranging the housing cover between the securing bolt head and the fastener is similar to the process describe and shown in FIG. 5B.

FIG. 8 illustrates an alternate exemplary embodiment of the invention illustrating a multi-component hook nut 800. Specifically, the multi-component hook nut incorporates a base extension tab 825 as a detachable element. Because this embodiment implements a detachable base extension tab 825, the fastening aperture 810 contour may correspond to the central portion's 815 contour. Moreover, after inserting the central portion 815 into the fastening aperture 110, the detachable base extension tab 825 lockably engages with the central portion 815. It is to be understood that such the detachable base extension tab is not limited to the circular locking mechanism illustrated in FIG. 8. The locking mechanism may be implemented as a securing pin engaged with a hole in the central portion 815 or any other acceptable locking mechanism that one skilled in the art would recognize. The manufacture of separate fastener and detachable base extension tabs may lead to less expensive production costs associated with simpler elements, as well as a less complex manufacturing and assembly process.

It should be understood that the above description is only representative of illustrative embodiments. For the convenience of the reader, the above descriptions have focused on a representative sample of possible embodiments, a sample that teaches the principles of the invention. The description has not attempted to exhaustively enumerate all possible variations. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that the embodiments and variations shown and described herein are merely illustrative of the principles of this invention and that various modifications may be implemented without departing from the scope and spirit of the invention.

1. A fastener comprising:
a base extension tab;
a fastening aperture engaging portion;
an extension block, wherein said extension block includes a bore configured to accept an elongated part of a securing bolt; and
wherein when said fastener is engaged with a first assembly element, the base extension tab is configured to contact an interior wall of the first assembly element, whereas the fastening aperture engaging portion is configured to contact the first assembly element in the plane of a fastening aperture.

2. The fastener of claim 1, wherein the base extension tab is configured with a contour complementary to the fastening aperture contour.

3. The fastener of claim 1, wherein the base extension tab is configured with a contour different from fastening aperture contour.

4. The fastener of claim 1, wherein the elements of the fastener are formed as a single element.

5. The fastener of claim 1, wherein the base extension tab is a removable element configured to be secured to an extension of the fastening aperture engaging portion.

6. The fastener of claim 1, wherein the base extension tab is configured to contact the interior wall of the first assembly element directly beneath the exterior wall where the extension block is configured to contact the exterior wall of the first assembly element.

7. The fastener of claim 1, wherein the base extension tab and the extension block are configured to apply structural support to the interior and the exterior wall respectively, on opposing sides of the fastening aperture in the first assembly element.

8. The fastener in claim 7, wherein the fastening aperture engaging portion is configured to apply structural support in the plane of the wall of the first assembly element on the same lateral side of the assembly wall as a base extension tab.

9. The fastener in claim 7, wherein the fastening aperture engaging portion is configured to apply structural support in the plane of the wall of the first assembly element on an opposing lateral side of the assembly wall of the first element as the base extension tab

10. The fastener in claim 1, wherein the base tab extension is configured with a contour corresponding to the fastening aperture.

11. The fastener in claim 10, wherein the fastener is configured so that the fastener is rotated prior to establishing contact areas with the housing.

12. A housing cover fastening assembly comprising:
a housing cover;
a housing;
a fastener further comprising an interior pressure application surface, a fastening aperture pressure application edge, and an extension body, wherein the extension body is configured to accept a securing body that extends through the housing cover securing the housing cover to the housing.

13. The housing cover fastening assembly of claim 12, wherein the housing is a cylindrical tube configured with at least one fastening aperture situated at a horizontal end of the cylindrical tube.

14. The housing cover fastening assembly of claim 13, wherein the outer circumference of the housing cover is formed to be secured to the housing by the securing body engaging with the fastener.

15. The housing cover fastening assembly of claim 14, wherein the fastener is threaded through the fastening aperture in the housing and maintains a plurality of contact areas with the housing.

16. The housing cover fastening assembly of claim 15, wherein the fastener is configured to be rotated to establish the contact areas.

17. The housing cover fastening assembly of claim 16, where the securing body is configured to thread with the extension body.

18. The housing cover fastening assembly of claim 17, wherein engaging the securing body and the fastener defines a cover securing portion of the assembly between the securing body and the fastener.

19. The housing cover fastening assembly of claim 18, wherein an edge of the housing cover is disposed within the cover securing portion, and engages the securing bolt head and the fastener.
